(19) United States
(12) Patent Application Publication
(10) Pub. No.: US 2013/0140896 A1
(43) Pub. Date: Jun. 6, 2013

(54) ADAPTIVE LOADING OF POWER SOURCES WITH HIGH AND NON-LINEAR OUTPUT IMPEDANCE: METHOD, SYSTEM AND APPARATUS

(71) Applicants: Victor Tzinker, Jerusalem (IL); Sergey Khariton, Nazareth Ilit (IL); Alexander Firtel, Ashdod (IL)

(72) Inventors: Victor Tzinker, Jerusalem (IL); Sergey Khariton, Nazareth Ilit (IL); Alexander Firtel, Ashdod (IL)

(21) Appl. No.: 13/600,517

(22) Filed: Aug. 31, 2012

Related U.S. Application Data
(60) Provisional application No. 61/529,507, filed on Aug. 31, 2011.

(51) Int. Cl. H02M 3/04

(52) U.S. Cl. CPC H02M 3/04
USPC 307/43; 323/364

(57) ABSTRACT

An adaptive loader for time varying, non-linear high-impedance power sources (HIS) comprising: an electronic converter, matching the impedance of said HIS to its load; at least one sensor; and a control system, controlling loading factor of the electronic converter to ensures impedance matching between said time varying HIS and its load. The loader may be used for any HIS like piezoelectric, photoelectric, thermoelectric, etc., sources. Impedance matching can be used for energy production, measurement of the input stimuli or both of them. The load may be any active or capacitive load including for example rechargeable battery. A piezoelectric generator producing time varying electrical signal in response to time varying mechanical strain can be used as HIS. For example the piezoelectric generator generates a pulse in response to a mechanical strain caused for example by one of passage of a vehicle or passage of a train.

### CROSS REFERENCE TO RELATED APPLICATION

This application is based upon and claims the priority of the filing date of co-pending commonly assigned U.S. Provisional Patent Application Ser. No. 61/529,507 filed on 31 Aug. 2011, which is incorporated within by reference in its entirety.

### FIELD OF INVENTION

The present invention is related generally to power conversion and data acquisition systems, and in particular to the method and apparatus for dynamic loading of sources with high and non-linear output impedance and data acquisition method and apparatus for the said sources.

### BACKGROUND OF THE INVENTION

With growing emphasis on alternative energies, the power conversion industry faces the task of developing efficient methods of converting energy from alternative sources to useful to electricity. The conversion of alternative energies to useful electric energy takes place, for instance, in photoelectric devices, piezoelectric devices, thermoelectric devices, photovoltaic devices, solar and geo-thermal systems, mechanical deformation energy systems, etc. We refer to these energy conversion devices as Alternative Energy Sources (AES). The electric energy produced by an AES usually needs to be converted to a form suitable for the load (for instance, charging a battery, powering of an electronic devices, etc.). To this end, DC/DC converters are typically used. Often AES are characterized by high output impedances and can be referenced as High Impedance Sources (HIS), which requires impedance matching between HIS and its load for best conversion efficiency. For constant input and load the HIS and load's impedances can be matched by adjusting the operation of the DC/DC converter. Often the AES sources receive their energy from environmental source which time varying. Thus, the HIS impedances are typically not constant but depends on the operating conditions (primarily, on the input energy). Since in practice usually input and output conditions vary, it is impossible to choose a constant operating mode of DC/DC electronic converter which matches impedances in all range of operating conditions. As a result, the whole system consisting of HIS, DC/DC converter and the load operates inefficiently and best efficiency of utilization of HIS is not achieved.

The example of implementation of HIS could be piezoelectric generator described in US Application 20100045111; Abramovich; Haim; et al.; titled “Multi-layer modular energy harvesting apparatus, system and method”.

US patent 20080122449A1; to Besser et al.; titled “Power Extractor For Impedance Matching”; discloses the apparatus for power extraction from the power source based on impedance matching technique. Said apparatus dynamically matches the impedance of the source and the load. Proposed apparatus doesn't have possibility to operate with HIS it intended for medium energy systems. In referenced patent there no described methods for operation with fast and high impedance sources.

FIG. 1 illustrates example of different signal profiles that may be encountered for different HIS as known in the art. These signals are inputs to the conversion unit and thus will be referred as “inputs” herein. The time dependence may be caused by the diurnal motion of Sun in solar energy systems, pulsed operation of piezoelectric devices in piezoelectric generators, etc. Moreover, in most cases the input varies because of changes in external conditions that are difficult or impossible to predict. For example, in photovoltaic and other solar energy systems significant changes may occur because of appearance of clouds or wind gusts.

Mechanical impulses in piezoelectric generators activated for example by passing vehicles such as cars, trucks or trains cannot be predicted as the signals depends on vehicles' speed, weight and other parameters.

Similarly; wind or ocean wave energy inputs also vary in unpredictable ways. Incorrect loading of HIS, whether overloading (with its output impedance higher than the impedance of the load) or under loading, not only impairs system efficiency but may lead to mechanical stresses in them and even to permanent damage.

FIG. 1 shows three examples of time dependent signals 10a, 10b, and 10c that may be generated for example by a mechanical pressure when a vehicle' wheel passing over a piezoelectric generator such as disclosed in the abovementioned art and characterized by different loading profiles.

### SUMMARY OF THE INVENTION

The purpose of the present invention is to provide a method for optimal loading in order to receive maximum energy from HIS and optimal measurement of its input stimuli in all range of input and output conditions. The solution adopted in the present invention is dynamical loading of the HIS with a current adaptively controlled so as to achieve instantaneous impedance matching. Two typical operating modes are given as examples:
the case of maximum utilization of the energy produced by the HIS
the most efficient conversion in the case where a constant output must be provided to the load.

The basic method of this invention, however, is general and is not limited to these operating modes.

We want to say that there three different cases:
a. when energy conversion into electric energy is provided at the same time with its producing like direct photo-electric conversion or direct piezoelectric conversion;
b. when energy is stored in some storage element like tank with liquid or in accumulator and stored energy is further conversed by HIS with relatively to the consumer high output impedance;
c. when energy storage element has relatively small time constant i.e., utilization of energy should be relatively fast.

In all cases matching converter is incorporated in order to match high output impedance of HIS with a load.

In case of direct conversion for optimal loading we need to estimate trajectory of input stimuli.

For acquisition systems which are used with HIS it is essential to receive output signal proportional to the input stimuli with the known factor and optimal measurement accuracy. For this purpose two conditions should be satisfied. The first one is that impedances of HIS and measurement unit should be matched in order to receive the said known factor in this case it equals 2. The second one is that magnitudes of the measured signals provide optimal measurement accuracy. The second condition becomes true when impedance matching is ensured. Thus one can see that in acquisition systems which operate with HIS the main condition for their proper operation is impedance matching.

Based on said above one can conclude that impedance matching is essential in both types of systems power conversion and acquisition.

It is an object of the present invention to provide high-efficiency power conversion in systems with high impedance sources and varying inputs by optimal loading of the sources.

It is another object of the present invention to provide correct and high accuracy acquisition in systems with high impedance sources and varying inputs by optimal loading of said sources.

It is one other of the present invention adaptive loading of HIS provides possibility to measure input stimuli and produce energy from the same HIS.

According to a first aspect of the invention, an electronic converter with a special control loop is placed between the high impedance source and the load.

According to a further aspect of the invention, the control loop optimizes the loading of the high impedance source and forms optimal operation conditions for the subsystem comprising the high impedance source and electronic converter.

According to a further aspect of the invention, the optimization of the control loop is performed continuously, adapting to varying input and load conditions.

According to a further aspect of the invention, an acquisition means are provided simultaneously with optimal loading of a high impedance source.

According to a further aspect of the invention, an impedance matching is used by acquisition system for correct and accurate measurement.

In an exemplary embodiment of the invention, an adaptive loader for time varying, non-linear high-impedance power sources (HIS) is provided, the loader comprising: an electronic converter, matching the impedance of said HIS to its load; at least one sensor; and a control system, controlling the loading factor of said electronic converter in response to signals from said at least one sensor to ensures impedance matching between said time varying HIS and its load.

In some embodiments the HIS is a piezoelectric generator producing time varying electrical signal in response to time varying mechanical strain.

In some embodiments the piezoelectric generator generates a short pulse in response to a strain caused by one of passage of a vehicle or passage of a train.

Input stimuli may have different trajectories which in some cases are similar to Gaussian and can be described by the term full width at half maximum (FWHM)

In some embodiments the HIS produces pulses having FWHM of less than 1 second.

In some embodiments the HIS produces pulses having FWHM of less than 1/10 second.

In some embodiments the HIS produces pulses having FWHM of less than 1/100 second.

In some embodiments the said HIS produces signal that changes by 30% in less than 1 second.

In some embodiments the HIS produces signal that changes by 50% in less than 1/10 second.

In some embodiments the electronic converter is a switch mode electronic converter.

In some embodiments the electronic converter is a step down converter.

In some embodiments the control system of said electronic converter has closed loop architecture.

In some embodiments the control system of said electronic converter has feed forward architecture.

In some embodiments the duty cycle of said electronic converter is controlled by said control system.

In some embodiments the load is a rechargeable battery.

In some embodiments the rechargeable battery powers said adaptive loader.

In some embodiments the adaptive loader is powered by said HIS.

In some embodiments the adaptive loader is powered by said HIS when rechargeable battery is not sufficiently charged.

In some embodiments the loader comprises a protector protecting said electronic adaptive loader against high voltage transients from said HIS.

In some embodiments the loader comprises an intermediate electronic converter between said HIS and said electronic converter.

In an exemplary embodiment of the invention, a method for construction of adaptive loader for non-linear high impedance power sources (HIS) is provided, said adaptive loader based on electronic conversion means load high impedance power sources proportionally to the input stimuli and ensures impedance matching between HIS and its load (input impedance of said adaptive loader) at each point of input stimuli trajectory in order to receive maximum energy from HIS, said adaptive loader comprising: current and voltage sensing means including input voltage and output energy sensing means; an electronic loader; control means of an electronic loader; an energy storage element; and a said adaptive loader power supply means.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Unless marked as background or art, any information disclosed herein may be viewed as being part of the current invention or its embodiments.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an illustration of different input stimuli profiles of high impedance sources as known in the art;

FIG. 2 is a schematic diagram of exemplary DC-DC conversion structure, constructed according to an exemplary embodiment of the present invention;

FIG. 3 is an illustration of the time dependence of the input voltage Vin, the output energy, and the loading factor of the electronic converter for case where the input impedance of electronic converter is matched with the output impedance of high impedance source according to an exemplary embodiment of the present invention;

FIG. 4A-C are illustrations of different loading profiles of HIS:

FIG. 4A is an illustration of loading profiles of HIS for an under-loaded source,

FIG. 4B is an illustration of loading profiles of HIS for an overloaded source,

FIG. 4C is an illustration of loading profiles of HIS for an optimally loaded source according to an exemplary embodiment of the present invention;

FIG. 5 is an illustration of an adaptive loading technique for high impedance source according to an exemplary embodiment of the present invention;

FIG. 6A is a schematic diagram of functional structure of the power conversion and simultaneous output energy measurement employed, constructed according to an exemplary embodiment of the present invention;

FIG. 6B shows the wave forms which describe the operation of the functional structure of FIG. 6a;

FIG. 7 shows an improved two state functional architecture for simultaneous power conversion and pulse energy sensing, constructed according to an exemplary embodiment of the present invention;

FIG. 8 shows the wave forms which describe the operation of improved two state functional structure of FIG. 7;

FIG. 9 shows an example of the functional structure with an external system regulation loop of the preferred embodiment, constructed in accordance with the principles of the present invention;

FIG. 10 is an exemplary architecture of an auxiliary power supply for the control system, constructed according to an exemplary embodiment of the present invention;

FIG. 11 shows parallel connection of HIS, constructed according to an exemplary embodiment of the present invention;

FIG. 12 explains the operation of the parallel arrangement described on FIG. 11;

FIG. 13 shows the improved power conversion structure for high impedance sources, constructed in accordance with the principles of the present invention;

FIG. 14 shows a basic functional structure of adaptive loader device, constructed in accordance with the principles of the present invention;

FIG. 15 shows a functional structure of adaptive loader device with internal output decoupling device, constructed in accordance with the principles of the present invention;

FIG. 16 shows a functional structure of adaptive loader device with internal power supply fed from the output of electronic loader, constructed in accordance with the principles of the present invention;

FIG. 17 shows a functional structure of adaptive loader device with internal storage element, constructed in accordance with the principles of the present invention;

FIG. 18 shows a distributed system for adaptive loading of HIS, constructed according to an exemplary embodiment of the present invention; and

FIG. 19 shows the architecture of acquisition system, constructed according to an exemplary embodiment of the present invention.

FIG. 20 shows system and a basic functional structure of adaptive loader device constructed according to an exemplary embodiment of the present invention.

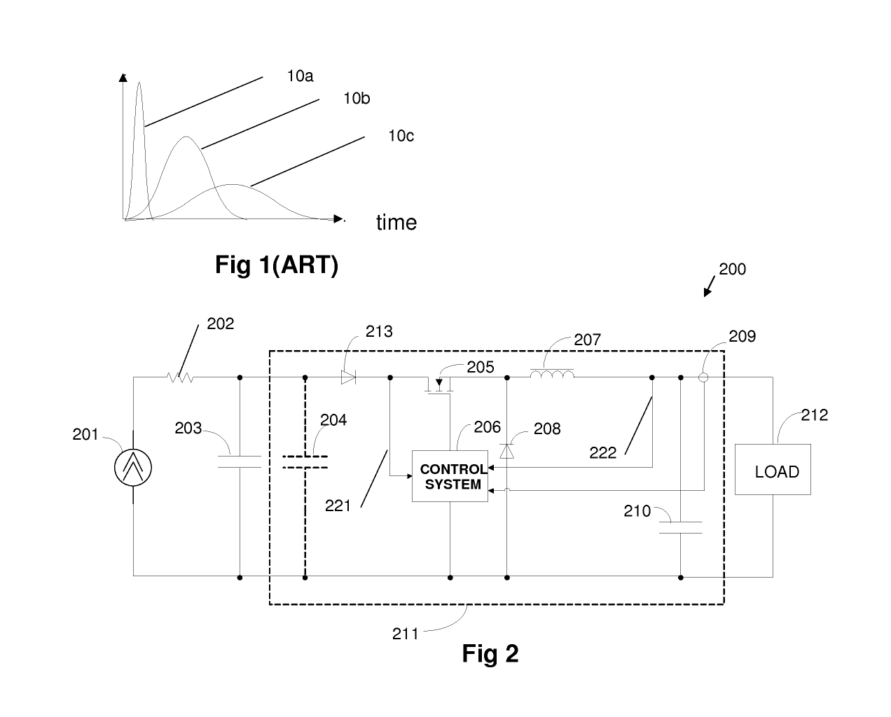

### DETAILED DESCRIPTION OF INVENTION

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The terms “comprises”, “comprising”, “includes”, “including”, and “having” together with their conjugates mean “including but not limited to”.

The term “consisting of” has the same meaning as “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof. Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements were omitted from some of the drawing.

It is a subject of the present invention is method for the construction of adaptive loaders based on electronic converter for loading of HIS, providing impedance matching of HIS output impedance with input impedance of an adaptive loader.

A feature of such electronic converter is a special control loop that ensures efficient or optimal loading of HIS. Said loader can be implemented as an adaptive DC/DC converter or in other ways known in art.

The invention is explained in an exemplary application to a piezoelectric generator which presents difficult conversion challenges since both the internal impedance and the amount of energy produced by HIS are highly dependent on the loading conditions but not limited to it. The control loop evaluates input and output parameters for efficient or optimal HIS loading.

FIG. 2 shows an exemplary equivalent schematics 200 comprising a high impedance source such as a HIS, an adaptive electronic converter, and the load.

A DC/DC converter is used for the explanation but the method is not limited to it. The actual implementation of the adaptive electronic converter 211 may be chosen based on the combined input and output requirements of the specific application. The high impedance source is shown as a current source 201, resistor 202 representing the internal impedance of the current source 201, and capacitor 203 representing the output capacitance of the source 201. The electronic converter 211, shown by way of example in the buck converter architecture, comprises an optional input capacitor 204, decoupling diode 213, MOSPET transistor 205, control system 206, inductor 207, decoupling diode 208, current sensor 209, and output capacitor 210. The load 212 is connected across the terminals of output capacitor 210. In order to achieve maximum efficiency, electronic converter 211 comprises sensors for measuring the input and output voltages and currents. However, in most of cases it is sufficient to measure only the input voltage (for example at line 221) and the output power (energy) by measuring output current (by sensor 209) and voltage of electronic converter 211 (at line 222).

In order to better describe the operation of the exemplary embodiment of present invention, we introduce the concept of a “loading factor” of an adaptive electronic converter, which we define as the ratio of the minimal impedance of the loader (electronic converter) to its instantaneous value. For example, in the Pulse Width Modulation (PWM) mode, the loading factor is proportional to the duty cycle of the PWM pulses; in pulsed operation with a fixed pulse width, the loading factor is proportional to the ratio of the pulse width to the time interval between the pulses, etc.

The function of the control system of the present invention is to control the loading factor in such a way that the output energy yield of the converter is maximized. This can be achieved as follows. Control system 206 samples the input voltage 221 of the electronic converter and its output power (energy rate, given by multiplying the output voltage 222 with the current 209). Each time the input voltage is changed, the loading factor is varied so as to maximize the output energy rate. The sampling frequency is set to be higher than the characteristic frequency (or rate of change) of the input so that for each input state it is possible to find the value of the loading factor leading to the maximal output energy rate. As a result of this “instantaneous” optimization, the system constantly follows the physical input to the HIS whether it is the changing mechanical pressure in a piezoelectric generator, changing heat input in a thermo-generator, or varying insulation in a Photo Voltaic (PV) system. In implementation of the invention for different HIS sources, characteristic times of the varying inputs should be taken into consideration. For example, in piezoelectric systems the characteristic times of the mechanical pressure vary from a few milliseconds up to several hundred milliseconds; in thermoelectric systems characteristic times of the heat input range from several seconds up to several minutes, and so forth. Correct estimation of the temporal change of the HIS input allows one to build an optimal loading profile of HIS using an adaptive DC/DC converter and, as result, to achieve maximum output energy (maximal conversion efficiency).

In the case of pulse operating of HIS like piezoelectric HIS performing the optimization, care must be exercised not to allow the system to reach an incorrect operating regime where the obtained local maximum may be considerably lower than the global maximum. Such a situation may arise if the changes of the loading factor are not synchronized with changes of input. In the correct operating regime, an increase of the input leads to an increase of output, provided that the loading factor is adjusted appropriately. If this is not so, then the converter is considerably overloaded or under-loaded and the obtained maximum is a spurious local one having no relation to optimal efficiency. If such a case is diagnosed, the system chooses a different initial value of the loading factor and the optimization is restarted. In order to find a good initial value of the loading factor, the control system varies the loading factor until the correct direction of the output change is obtained and, further, the derivative of the output current as a function of input voltage is maximized. Note that in systems with slowly changing inputs the above mentioned problem is easy to solve.

In a typical piezoelectric HIS, the input mechanical pressure is applied as a series of pulses of variable duration, amplitude and/or shape. In this case, the system of FIG. 2 works as follows. Once the input pressure is applied and the HIS output voltage starts growing, the control system 206 initiates the operation of the buck electronic converter 211 which starts charging the output capacitor 210. Control system 206 also starts sampling the input voltage of the electronic converter and its output current. When the input changes, control system 206 calculates the derivatives of the input voltage and output current and adjusts the loading factor in such a way so as to achieve maximal output energy from each input energy pulse. Due to the fact that control system 206 tries to achieve correct loading factor for each next point, the result should be maximal or near maximal area under the output power curve consisting of instantaneous power points. The initial value of the loading factor is chosen as some pre-calculated value depending on the parameters of the converter 211 and the maximum energy that HIS can produce.

When the MOSFET transistor 205 is switched off (and does not conduct), the HIS current source 201 charges the internal capacitance 203 of the HIS and the optional input capacitance 204 (if present) of the electronic converter up to some voltage level depending on the input stimulus and loading factor. When transistor 205 is switched on by a control signal from control system 206, its current is a sum of two currents, the current of current source 201 and the discharge current of capacitors 203 and 204. During the time when transistor 205 is switched on there occurs a voltage drop on capacitors 203 and 204. This voltage drop depends on the instantaneous output impedance of HIS and the instantaneous impedance of its load, in our case the instantaneous input impedance of the buck electronic converter 211. The latter depends on the operation frequency of the converter, inductance of the inductor 207, and the operational duty cycle. During the time when the MOSFET transistor 205 is switched off, the energy stored in the inductor 207 is transferred to the load and to the smoothing capacitor 210. During this time the capacitors 203 and 204 are re-charged by the current source 201.

In real circuitry with switching electronic converters one should discuss impedance matching averaged over the switching time period. The operation of the system over this time can be explained as follows: for the period of time when MOSFET transistor 205 is switched on, the converter's input capacitance (capacitors 203, 204) discharges into a relatively low input impedance of electronic converter 211. During this short time, there is a mismatching of the output impedance 202 of current source 201 and the input impedance of electronic converter 211, which leads to energy losses (decrease of the output energy) and reduction of the yield. In order to minimize this loss, one needs to optimize the operating frequency of the control system and the amount of energy consumed at each pulse which generally depends on the input stimulus of the HIS. The greater the input stimulus, the longer switching pulse of transistor 205 may be in “on state” in a PWM type system and/or a higher switching frequency may be used in a system with fixed “on state” duration, or a combination of increased switching frequency and duration. On the other hand, with the increase of the operation frequency the commutation losses increase proportionally. The major challenge is to arrive at optimal parameters (operation frequency and pulse width) for a required frequency range of the input. For example, assume we want to sample any input 1000 times per its period. This means that the operation frequency of the electronic converter must change from 1 kHz for input frequency of 1 Hz up to 10 kHz for input frequency of 10 Hz. Since the power produced in piezoelectric HIS is very low to start with, a careful tradeoff must be worked out between increasing operating frequency for better functioning of the control system on the one hand and avoiding excessive commutation losses on the other hand.

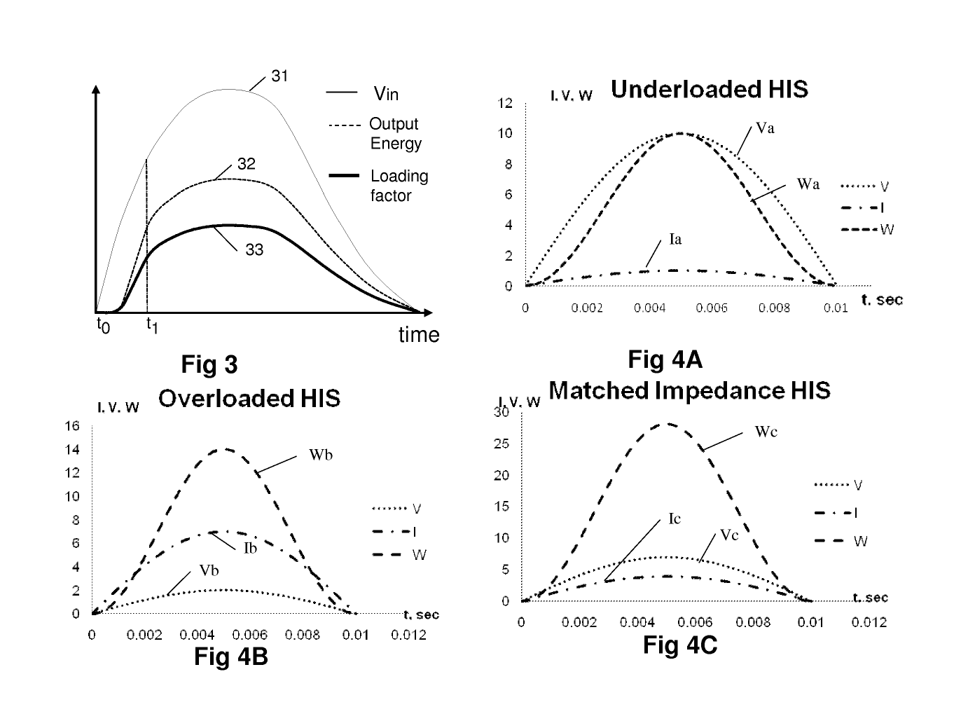

FIG. 3 shows the time dependence of the input voltage Vin 31, the output energy rate 32, and the loading factor 33 of the electronic converter for case where the input impedance of electronic converter is matched with the output impedance of high impedance source. With optimal loading, all three curves are proportional to each other, except during the start-up time from t0 to t1 which is needed to for the electronic converter to generate enough energy to start its operation.

FIGS. 4A 4B and 4C illustrate three different loading profiles of a HIS. FIG. 4A shows a non-optimal loading profile where the HIS is under-loaded (its impedance is lower than the impedance of the load). The output voltage depends on both the input and the input impedance of the load. With increase of the input stimuli, the output voltage of HIS Va rises very rapidly and reaches very high values while the output current Ia remains very low. This loading profile is not only not optimal but even dangerous since the output voltage can reach excessive levels and cause physical damage to the piezoelectric converter itself. The output energy rate (power transfer to the load) at time “t” is given by W(t)=V(t)*I(t), and is marked by the curve Wa.

FIG. 4B shows another non-optimal loading profile corresponding to overloading of the HIS. Here the output voltage of the HIS depends mainly on the impedance of the load. Here the current Ib is high, while the output voltage Vb is low and consequently, the output energy rate Wb is not optimal.

The optimal loading profile of the HIS is shown in FIG. 4C. This operation mode is characterized by maximal product Wc of the HIS output voltage Vc with the current Ic, which is equivalent to matched impedances of the HIS and load.

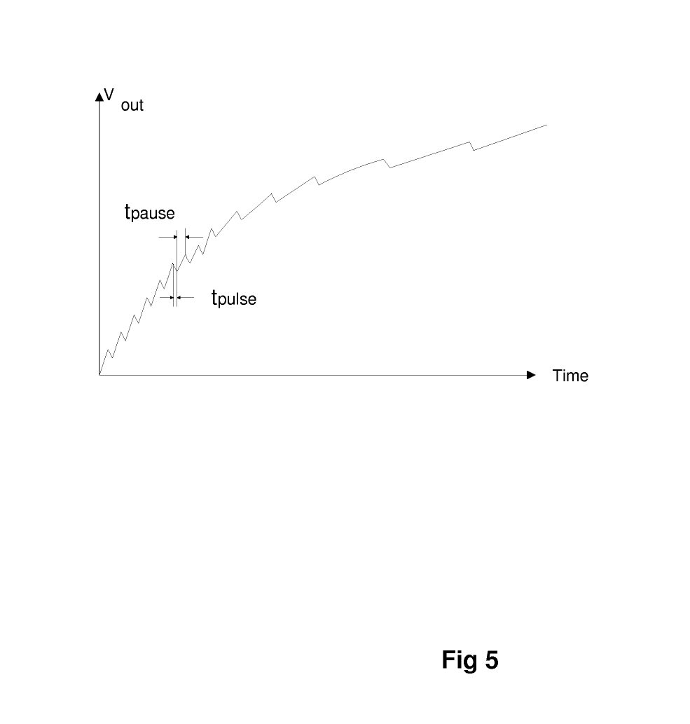

FIG. 5 illustrates the principle of adaptive loading of a high impedance source as described above. FIG. 5 depicts a graph of the HIS output voltage 221 vs. time during a part of the source 201 pulse. In this exemplary embodiment, the control system 206 generates control pulses with a fixed pulse width tpulse and varies the pause duration tpause between pulses. Each such control pulse turns on switch 205. Pulse width is chosen based on the output capacitance of the high impedance converter, the fraction of the energy that defines the input impedance of the electronic converter, and the inductance of the electronic converter. Varying the pause duration between control pulses makes it possible to track the changes of the output impedance of the converter

In dealing with a piezoelectric HIS a protection means should be used because in a no-load condition the output voltage of the HIS can rise in an uncontrolled way and may damage the electronic converter or the piezoelectric HIS itself. The protection means can operate, for example, according to the following algorithm: when the slope of the output voltage of the piezoelectric converter increases, the input impedance of the electronic converter is decreased. If this is not sufficient to reduce the voltage, then the switch of the electronic converter is opened and the load is connected directly to piezoelectric converter. Due to the low impedance of the load, the output voltage of the piezoelectric converter will be restricted. For safety reasons it is possible to build the protection means using additional independent circuitry that operates faster than the main control loop.

We now describe the special energy measurement techniques adopted in the present invention. Standard techniques which employ low pass filters are difficult to use with rapidly changing input characteristics of piezoelectric sources and some other HIS. In such cases it is essential to measure the pulse energy in each commutation period of the electronic converter, which will also enable a faster response of the adaptive controller.

The distinguishing feature of the adopted sample-and-hold techniques is that the measuring capacitor is an inherent a part of the adaptive DC/DC converter.

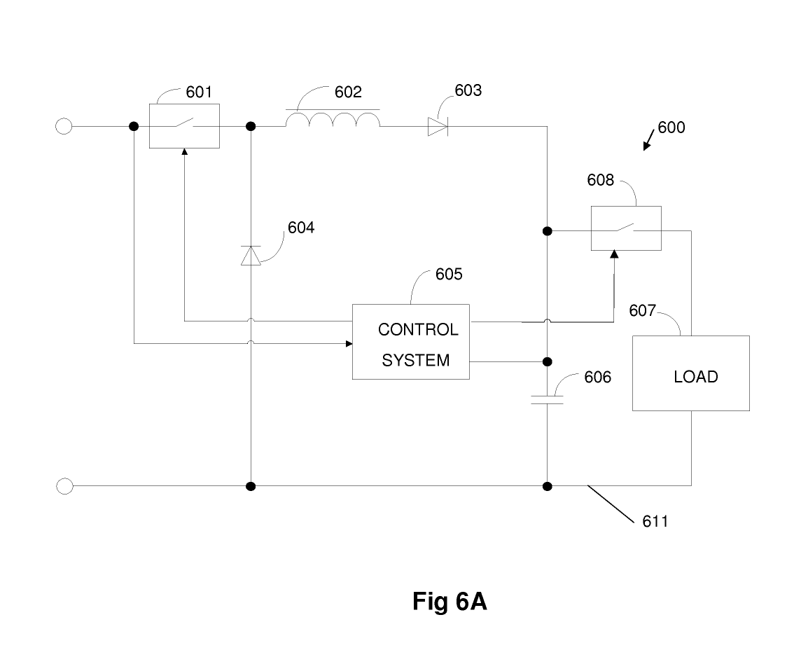

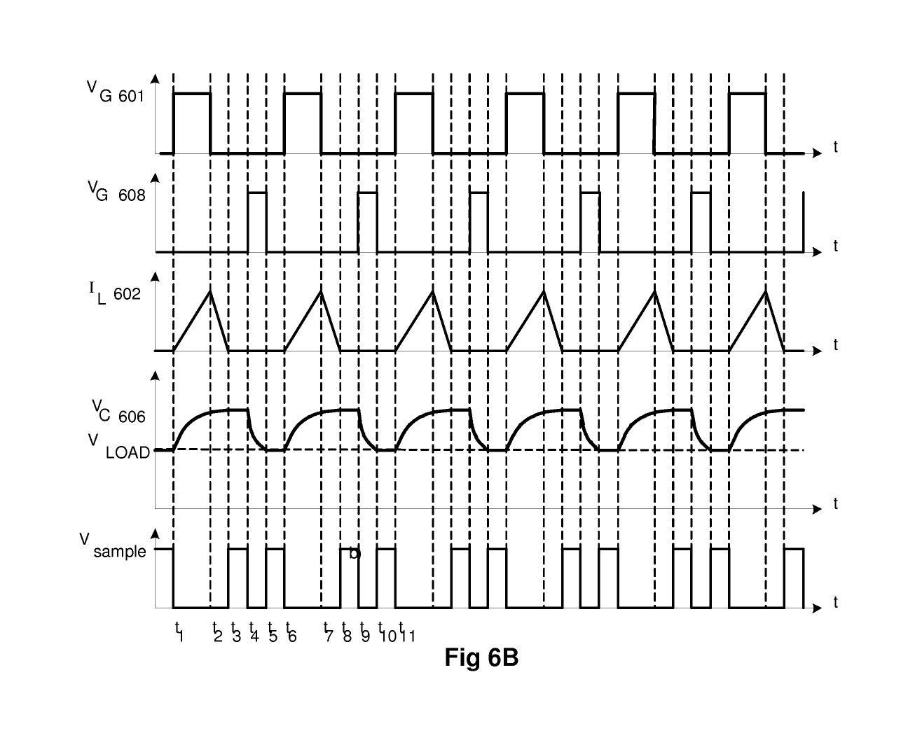

FIGS. 6A & B shows respectively the functional structure 600 of the power conversion and simultaneous output energy measurement employed in another exemplary embodiment of the present invention and waveforms which explain its operation. In FIG. 6A, Buck topology is shown for the sake of concreteness, but the technique is not limited to it. The controlled switch 601 at the input of the buck converter can be implemented as a MOSFET transistor or as a bipolar transistor. The output of the controlled switch 601 is coupled to the first terminal of inductor 602 and the cathode of diode 604. The anode of diode 604 is connected to the common wire 611. The second terminal of inductor 602 is coupled to the anode of the decoupling diode 603. The cathode of decoupling diode 603 is connected to the first terminal of controlled switch 608 and to the input of control system 605 and the first terminal of capacitor 606. The second terminal of the controlled switch 608 is connected to the first terminal of load 607. The second terminal of capacitor 606 is connected to the common wire 611 together with the second terminal of the load 607.

In order to achieve an accurate measurement it is essential to synchronize the measurements with the commutation period of the buck converter in such a way that the measurements is carried out at the end of the commutation period of the electronic converter, i.e., at the end of the discharge process of the energy transfer element (the inductor of the buck converter). In some embodiments one measurement may be performed after several commutation periods of the electronic converter.

The energy sensing functional structure described above operates in the following way. At the start of the measurement process switch 608 is switched on, switch 601 is switched off, control system 605 measures the voltage on measurement capacitor 606 which is equal to the voltage on load 607 (for example, a battery). At the end of the measurement period, control system 605 turns on the switch 601 and turns off switch 608. During the buck commutation process the capacitor 606 charges through inductor 602 and decoupling diode 603. For the next measurement, control system 605 measures the voltage rise on the capacitor 606, turns on the switch 608 to connect the discharge measurement capacitor 606 to the load, turns on the switch 601, turns off switch 608 and calculates the energy that was stored in the capacitor.

In the case of a capacitive load (an accumulator), in order to not destroy efficiency it is necessary to limit the current surges by a soft commutation element discharging the capacitor 606. For this reason an inductor should be placed between controlled switch 608 and load 607.

The proposed technique may be difficult to implement at high operation frequencies of the electronic converter because the measurement time must be much smaller than the commutation period of the electronic converter for example during the time between t₃ to t₄ and between t₅ to t₆ of FIG. 6B. This may be overcome by taking measurements in a number of conversion-measurement networks so that every next measurement is conducted by different network.

FIG. 6B shows waveforms which explain operation of the output energy measurement technique employed in the exemplary embodiment of FIG. 6A.

In this figure, V_{G} 601 is the control voltage that controls switch 601, where “high” state indicates that the switch is conducting.

V_{G} 608 is the control voltage that controls switch 608, where “high” state indicates that the switch is conducting.

I_{L} 602 is the current in inductor 602. Note that the current start to increase as soon as switch 601 is turned on, and start decreasing when switch 601 is turned off.

V_{c} 606 is the voltage on capacitor 606. Note that the voltage increase due to the current I_{L} 602, and decreasing when switch 608 is conducting. Capacitor 606 is discharges to the steady state voltage of the load 607 as indicated by the dash line V_{Load}.
Vₛₐₘₚₗₑ 608 is indicates the times during which measurements of the voltage on capacitor 606 may be performed.

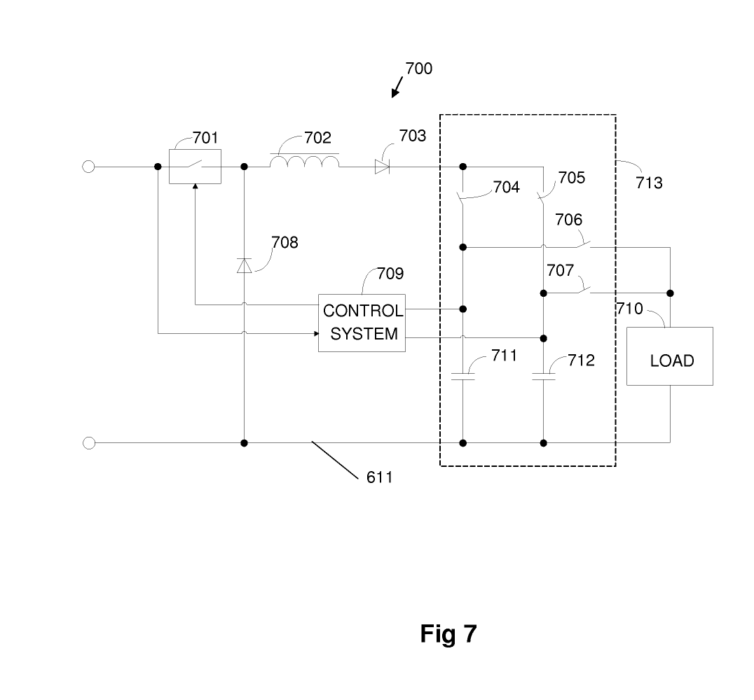

FIG. 7 shows an improved two state functional architecture 700 for simultaneous power conversion and pulse energy sensing constructed according to another exemplary embodiment of the present invention. This architecture can be used also at high commutation frequencies. In comparison with FIG. 6, this structure has two measurement capacitors 711 and 712 which are connected with their first terminals to the common wire 611 and with their second terminals to the cathode of decoupling diode 703 through the controlled charge switches 704 and 705, respectively. Load 710 is connected across the terminals of capacitors 711 and 712 through the controlled discharge switches 706 and 707 correspondently. Control system 709 measures the voltage on capacitors 711 and 712. For clarity, the control lines controlling switches 704, 705, 706, and 707 were not drawn in this figure.

The main distinguishing feature of the architecture 700 seen in FIG. 7 is that it comprises an energy measurement circuit 713 which comprises two independent measurement groups that operate in turns, which makes it possible to commutate these groups and carry out the measurements at half the speed of the commutation period of the electronic converter.

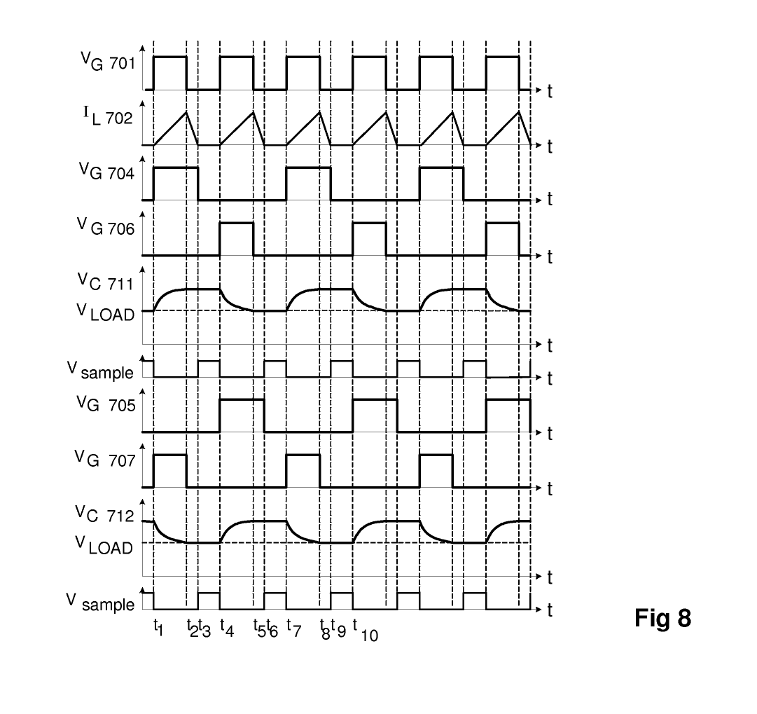

FIG. 8 shows the waveforms which describe the operation of the energy sensing structure shown on FIG. 7. The designation of the waveform follows the same convention as in FIG. 6B. It operates in the following way. The measurement period of each independent group is defined as period of the control signals to switch 704 or 705. We describe the operation of only one measurement group as the other group operates in the same way but with a time shift. Each measurement group operates at a half the frequency of switch 701. At a time t1 at the beginning of the measurement period switch 704 is turned on synchronously with switch 701 and switch 705 is turned off. During the period from t1 to t2 the measurement capacitor 711 is charging. At time t2 switch 701 is turned off. From t2 to t3 the current of inductor 702 still flowing and charging capacitor 711. At time t3 switch 704 is turned off. During the period from t3 to t4 control system 709 measures the voltage on capacitor 711. Switch 706 turns on at time t4 and capacitor 711 is connected to load and starts discharging up to time t5 when switch 706 turns off. During the time between t6 and t7 control system 709 measures the voltage on capacitor 711 (which is equal to the load voltage) and calculates the energy which is transferred to the load. At time t5 switch 704 turns on and the sequence is repeated.

The impedance matching techniques described above maximize the power transferred from the HIS to the load 710. These techniques offer a good solution for grid connected systems. But in many cases, for example, in telecommunication applications, the goal is, rather, to supply a constant voltage (power) to the load. This is a different task and therefore a different system approach may be taken. It is known that in order to maintain a specific output parameter constant, a corresponding feedback loop should be employed. The above discussed techniques do not contain such a loop and therefore may not be able to achieve this task. In some systems discussed in background of the present invention, such as thermoelectric plants with self-contained liquid recirculation, there is a possibility to control the input stimulus (for instance, by controlling the hot liquid flow by an appropriate valve or pump) and this can be used to close the system control loop. Some energy excess should be maintained in the system in order to compensate for changes of the load during the response time of the system control loop. For this purpose a buffer element described below is used. The goal of the system control loop is to perform the system optimization in order to achieve maximal system efficiency for a constant output. In thermoelectric systems impedance matching is especially important because in addition to Ohmic losses, the mismatching leads to a decrease of the temperature difference between hot and cold sides of the thermoelectric generator, which further reduces the system conversion efficiency.

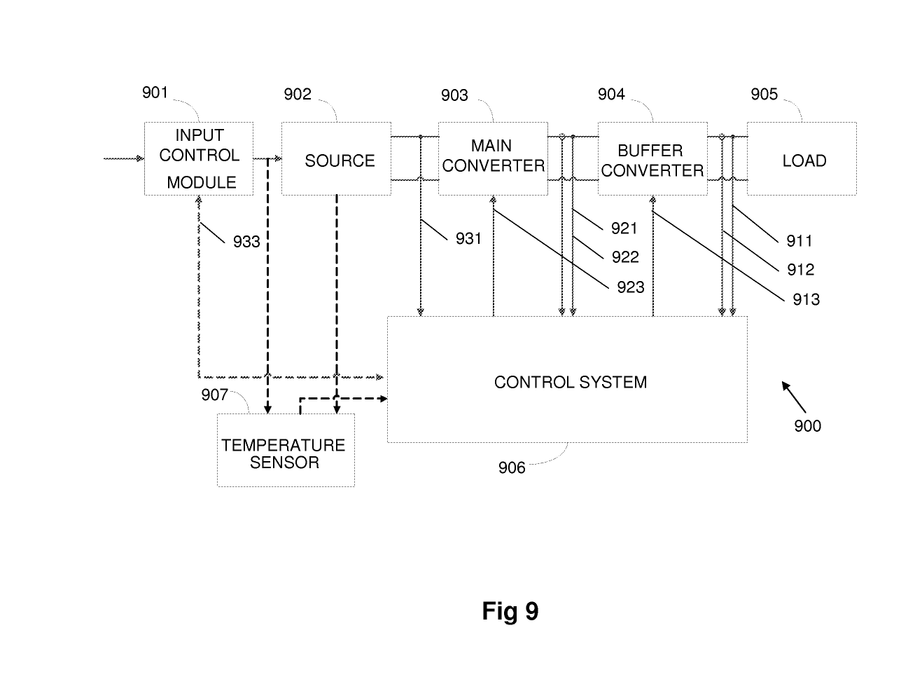

FIG. 9 shows an example of the functional structure of system 900 with an external system regulation loop of the exemplary embodiment constructed according to the principles of the present invention. Input control module 901 receives the input stimuli from the environment and regulates the incoming energy quantity to the system. Input control module is controlled by the control system 906 via input control signal 933. In some cases input control signal channel may be a bi-directional. For example real azimuth in sun tracking systems which is indirectly connected to the real output power of solar panel but is needed in order to control servo drive. The output of the input control module 901 is coupled to the input of the source 902 which can be a thermoelectric, photoelectric, or other converter. The output of the source 902 is connected to the input of the main converter 903 which can be any suitable electronic converter. The main converter is also controlled by control system 906. The output of the main converter is coupled to the input of buffer converter 904 which can be any suitable electronic converter. The buffer converter is needed in order to compensate the changes in the energy demand of the load during the response time of the system control loop. In many cases a bulk or an energy storing element (capacitor or accumulator) may be placed between the main and buffer converters (903 and 904 respectively). This optional storage element (not seen in this figure) can be physically placed either in the main or buffer converter. The output of buffer converter 904 is connected to the load 905. Signals of the output voltage from the output of source 902, signals of voltage and current from the output of main converter 903, and signals of voltage and current from the output of buffer converter 904 are fed to the input of control system 906. The signal from the temperature sensor 907 is also fed to control system 906.

System 900 seen in FIG. 9 contains three local control loops, a system control loop, and an additional control based on a temperature sensor 907 measuring for example the temperature difference ΔT on the thermoelectric generator (TEG).

The first local control loop controls the changes in the load. This loop is closed by the voltage signal 911 and current signal 912 from the output of buffer converter 904 and the control signal 913 to buffer converter 904 produced by control system 906

The second local control loop controls the input conditions of buffer converter 904. This loop is closed by the voltage signal 921 and current signal 922 from the output of main converter 903 and the control signal 923 to main converter 903 produced by control system 906.

The third local control loop is closed by the output voltage 931 of source 902 and the control signal 923 to main converter 903 produced by control system 906. This loop enables matching of the output impedance of source 902 and the input impedance of main converter 903 in order to maximize the output power of source 902 for a given source input. In other words, this loop ensures maximum efficiency of this conversion stage. The first two local control loops ensure optimal conditions for the next stage of power conversion. The third local control loop ensures optimal loading of the previous conversion stage—the high impedance source 902.

The system control loop is closed by the product of signals from all local control loops and the control signal 933 to input control module 901 which can control the input stimuli for the whole conversion system. In some systems this control can only reduce the input of the alternative energy into the conversion system. In other systems it can be a fully functional control loop i.e., able to both reduce and increase the energy input in a defined range. All the above control loops may also provide protection means for the next conversion stage. In the case of Thermoelectric Generator (TEG) where the control loop is closed by the output power, it may be necessary to have an excess of energy in order to maintain constant output power.

The buffer element of the buffer converter 904 as described above can be either a capacitor or an accumulator sufficient for feeding load operation for a required time period. In the steady state there is no current flow through the buffer element. The current flows only during transient processes. Therefore during steady state operation there are no energy losses in the buffer element. Energy losses occur only during transient process and are proportional to the energy of the transient process. In the case of a capacitor these losses are insignificant; in case of an accumulator the energy losses are equal to 50% of the transient process energy. In this case the system control loop is closed in the following way: control system 906 measures the input voltage on the buffer element (in the steady state this voltage is constant). When a change of either input or output conditions occurs, control system 906 produces a control signal to input control module 901 which closes the system loop. In case of voltage rise on the buffer element, control system 906 produces a control signal 933 for input control module 901 in order to reduce the input stimulus. In the case of voltage drop on the buffer element, control system 906 produces a control signal 933 for input control module 901 in order to increase the input stimulus.

We now turn to the discussion of the loading profile of the source 902. Control system 906 builds the consumption current i from the source 902 in such a way that it will result in a maximum absolute time derivative di/dt during the whole interval of the current curve and will be proportional to the changes of its output voltage. In this way control system 906 quickly matches the output and input impedances of source 902 and main converter 903.

In some systems such as piezoelectric HIS, the input consists of pulses with relatively long time intervals between them, i.e., the input may be a single pulse or a series of isolated pulses. Therefore, the converter is not able to supply continuous power to power the control system and exemplary embodiments of present invention may employs a special operating mode of the converter for such input. With arrival of each input pulse to the HIS, the converter delays the supply of power to the control system in order to accumulate a sufficient amount of energy to start the operation of the control system.

The power supply to the control system has fast start after the delay and preferably does not consume energy during the pauses between pulses of input energy. After the control system is powered and the power converter starts its operation, a fraction of the converted energy is diverted for supplying the control system. It is clearly important that the power consumption by the control system should be low.

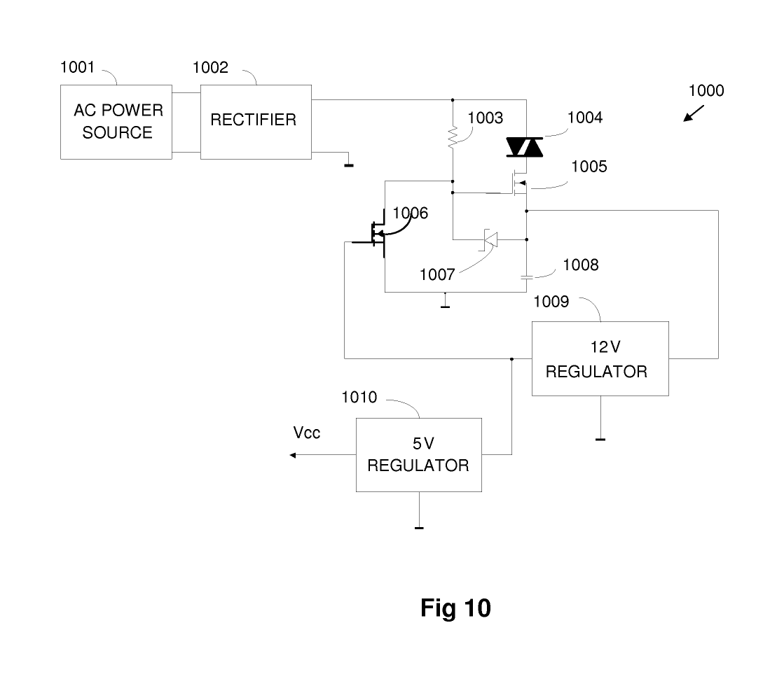

FIG. 10 represents an exemplary architecture of an auxiliary power supply 1000 for the control system constructed according to the principles of the present invention which is useful for HIS but not limited to them. The output of the AC power source 1001 is connected to the input of rectifier 1002 which intended for rectification of the input AC voltage. Resistor 1003 and DIAC 1004 (a diode for alternating current', is a diode that conducts current only after its break-over voltage has been reached momentarily) are connected with first terminals to the output of rectifier 1002. Second terminal of resistor 1003 is connected to cathode of Zener diode 1007, the gate of transistor 1005 and the drain of transistor 1006. The second terminal of diodes 1004 is connected to the drain of transistor 1005. The source of transistor 1005 is connected to the first terminal of capacitor 1008, the input of the 12V voltage regulator 1009 and the anode of Zener diode 1007. Zener diode 1007 is connected across the gate-source junction of transistor 1005 for the gate protection means. The second terminal of capacitor 1008, and source of transistor 1006 are connected to the common net. The output of the 12V voltage regulator 1009 is coupled with the input of the 5V voltage regulator 1010 and the gate of transistor 1006. The output of the 5V voltage regulator 1010 is connected to the Vcc pin of the control system (not shown).

We explain the operation of the above circuitry starting from zero initial conditions, i.e., when the voltage on capacitor 1008 is zero and starts to rise. When the voltage on the output of rectifier 1002 reaches the opening threshold of the MOSFET transistor 1005, the latter opens and the output voltage of rectifier 1002 is applied to the DIAC 1004. During this time capacitor 1108 charges through resistor 1003 and Zener diode 1007. When the output voltage of rectifier 1002 reaches the breakdown voltage of DIAC 1004 the latter begins to conduct, capacitor 1008 starts charging, the voltage on it starts to rise and is applied to the input of the 12V voltage regulator 1009. The optional 12V regulator may be needed because some control circuitry may need 12V and some may need 5V power supply. The output voltage of the voltage regulator 1009 in turn also starts to rise. When the output voltage of the voltage regulator 1009 reaches the opening threshold of MOSFET transistor 1006, the latter opens and a negative bias is applied to the gate of MOSFET transistor 1005. Transistor 1005 closes and charging of capacitor 1008 stops. When the output voltage of voltage regulator falls below the opening threshold of the MOSFET transistor 1006, the cycle is repeated. During the regular operation the control system receives its power from the commutation process of electronic converter. The outputs of the described auxiliary power supply may be connected to the control system by means of decoupling diodes (not shown and optionally placed on one or both 5V and 12V lines).

In order to generate a significant amount of power by HIS, several HIS may have to be employed, connected in parallel through decoupling elements forming an array of HIS as described below.

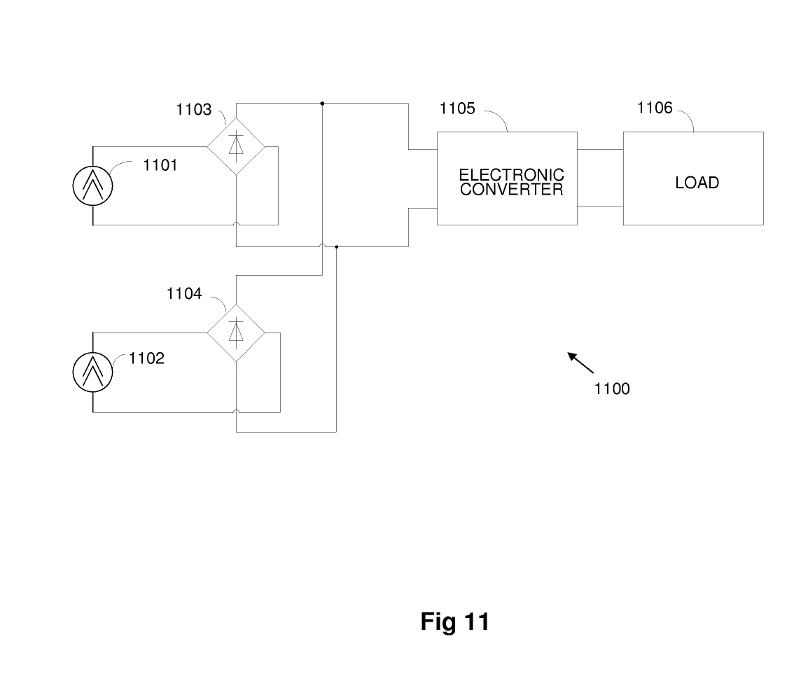

FIG. 11 shows a system 1100 having parallel connection of HIS constructed to an exemplary embodiment of the present invention. For simplicity of explanation, the HIS are represented as current sources. 1101 and 1102, which are connected to the inputs of bridge rectifiers 1103 and 1104 respectively. Appropriate output terminals of the bridge rectifiers are connected in parallel and are fed to the corresponding input terminals of electronic converter 1105 which matches the equivalent output impedance of current sources 1101 and 1102 with impedance of the load 1106 connected to its output.

It should be noted that more than two HIS sources (each with its bridge rectifier) may be connected.

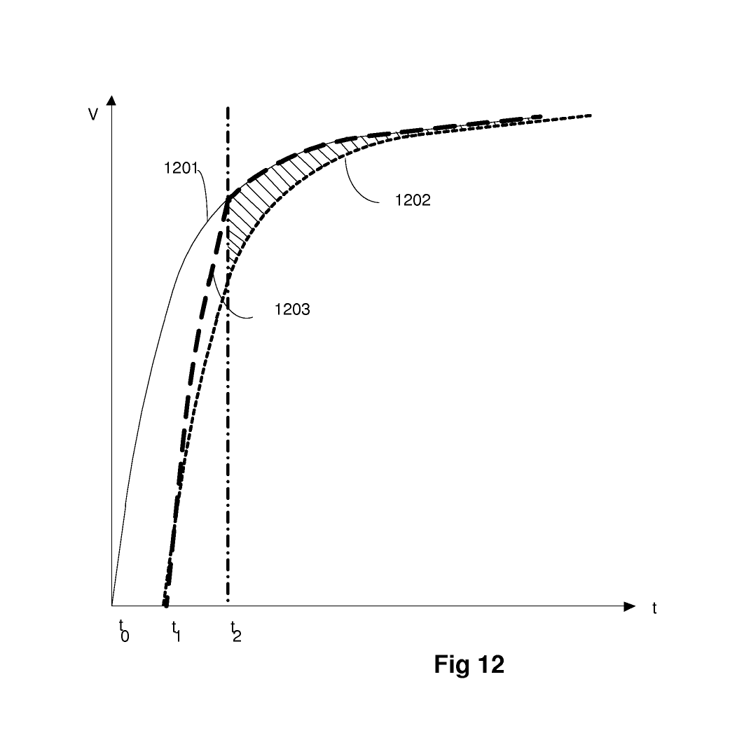

FIG. 12 explains the operation of the parallel arrangement described on FIG. 11. This figure illustrates two output voltage curves of HIS-equivalent current sources 1101 and 1102. Curve 1201 corresponds to the current source 1101 and curve 1202 corresponds to current source 1102. These two voltage curves may be phase shifted relative to each other due to the presence of bridge rectifiers 1103 and 1104 which decouple the current sources and eliminate equalizing current flows in the event that the signals produced by current sources 1101 and 1102 are not equal (FIG. 11). This is the case, for example when two piezoelectric generators are activated, each by another wheel of a passing vehicle, and one generator (1101) is activated first, for example as a result of the angle of approach or the vehicle or the location of the generators. At time tₒ the input energy is applied to HIS 1101; its output rises with rate defined by its own impedance and the corresponding loading factor. At time t₁ an input stimulus is applied to HIS 1102. Its voltage reaches the voltage value of HIS 1101 at a time t₂. After this time, both HIS have the same voltage level depending on their total impedance and the instantaneous loading factor. Using this connection method and the adaptive loading method of the present invention there are no energy losses because impedance matching is carried out in each point of the loading trajectory. In other words, the loading factor is smaller when not all HIS are activated and it changes according the activation rate of other HIS. In the case of non-adaptive loading, energy losses do occur.

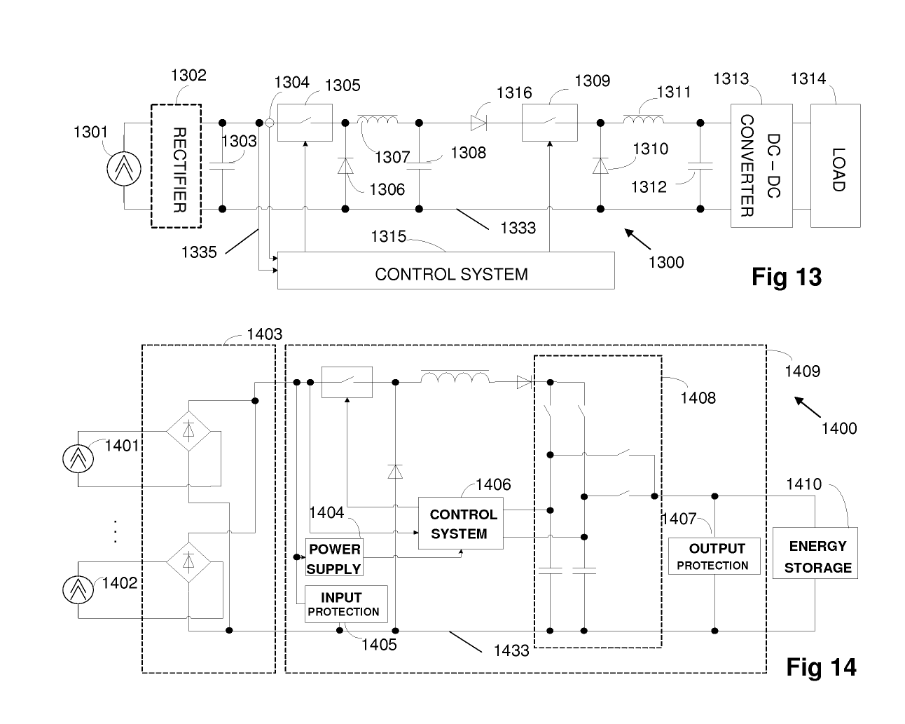

FIG. 13 shows the improved power conversion structure 1300 for high impedance sources constructed according to an exemplary embodiment of the present invention. The typical example of this power conversion structure application is piezoelectric systems but its usefulness is not limited to them. This power conversion structure 1300 enables to improve total conversion efficiency by diminishing the following phenomenon of power conversion structure 200 shown on FIG. 2. Power conversion structure 200 shown on FIG. 2 has a disadvantage in high voltage applications, namely during the “on” time of MOSFET transistor 205 input high impedance source almost shorted, because of load 212 low voltage. This leads to significant power losses during the on time of MOSFET transistor 205. In order to overcome the described above phenomenon, we placed additional controlled switch 1305, diode 1306, and inductor 1307.

HIS is presented by current source 1301 its terminals are connected to the optional input terminals of rectifier 1302 which is full wave rectifier. Capacitor 1303 is connected across the output terminals of rectifier 1302. First terminal of current sensor 1304 is connected to positive output of rectifier 1302. Negative output terminal of rectifier 1302 is connected to common wire 1333. Second terminal of current sensor 1304 is connected to input of controlled switch 1305. Output of controlled switch 1305 is connected to the first terminal of inductor 1307 and cathode of diode 1306. Anode of diode 1306 capacitor 1303 is connected to common wire 1333. Second terminal of inductor 1307 is connected to the first terminal of capacitor 1308 and input terminal of controlled switch 1309. Second terminal of capacitor 1308 is connected to common wire 1333. Output terminal of controlled switch 1309 is connected to the first terminal of inductor 1311 and cathode of diode 1310. Anode of diode 1310 is connected to common wire 1333. Second terminal of inductor 1311 is connected to the first terminal of capacitor 1312 and positive input terminal of DC-DC converter 1313. Second terminal of capacitor 1312 and negative input of DC-DC converter 1313 are connected to common wire. Output terminals of DC-DC converter 1313 are connected to the corresponding terminals of load 1314. Control system 1315 has measurement inputs for input voltage 1335 and input current from current sensor 1304. Output terminal of current sensor 1304 and positive output of rectifier 1302 are connected to corresponding measurement inputs of control system 1315.

FIG. 14 shows system 1400 and a basic functional structure of adaptive loader device 1409 constructed according to an exemplary embodiment of the present invention. Adaptive loader device 1400 combines the multi-source combining 1403 depicted in FIG. 11 and the energy measurement circuit 1408 (seen as 713 in FIG. 7). Outputs of the HISs represented on figure as current sources 1401 and 1402 are connected to the corresponding inputs of array of decoupling devices 1403. All outputs of decoupling devices are connected in parallel. Array of decoupling devices 1403 can be implemented on half wave rectifiers in case of DC input signals and on full wave rectifiers in case of AC input signals. Output terminals of array of decoupling devices 1403 are connected to the corresponding input terminals of electronic loader 1409. Output terminals of electronic loader 1409 are connected to the corresponding terminals of a load such as energy storage element 1410.

Electronic loader 1409 comprises an input protection element 1405 connected across the input terminals of electronic loader 1409 in order to protect electronic converter during input overvoltage conditions. Input terminals of internal power supply 1404 are connected to appropriate input terminals of electronic loader 1409. Output terminals of internal power supply 1404 are connected to the appropriate terminals of control system 1406. Control system 1406 receives feedback signals from output energy measurement means 1408 which are a part of power conversion stage described in details above on FIG. 7. Output terminals of output energy measurement means are the output terminals of electronic loader 1409. Output protection element 1407 is connected across the output terminals of electronic loader 1409 in order to protect the output of electronic loader 1409 during output overvoltage conditions. Protection elements 1405 and 1407 may be elements such as Zener diode, transient voltage suppressing diode (TVS diode) or varistor connected between the terminal on which over-voltage may develop and the common wire 1433. Protection element 1407 should be chosen so that provide overvoltage protection and load role in case of disconnection of energy storage element 1410. Power supply 1404 may optionally be of the construction 1000 seen in FIG. 10, or other appropriate construction. Alternatively, external power supply may be used, powered for example by the energy storage 1410.

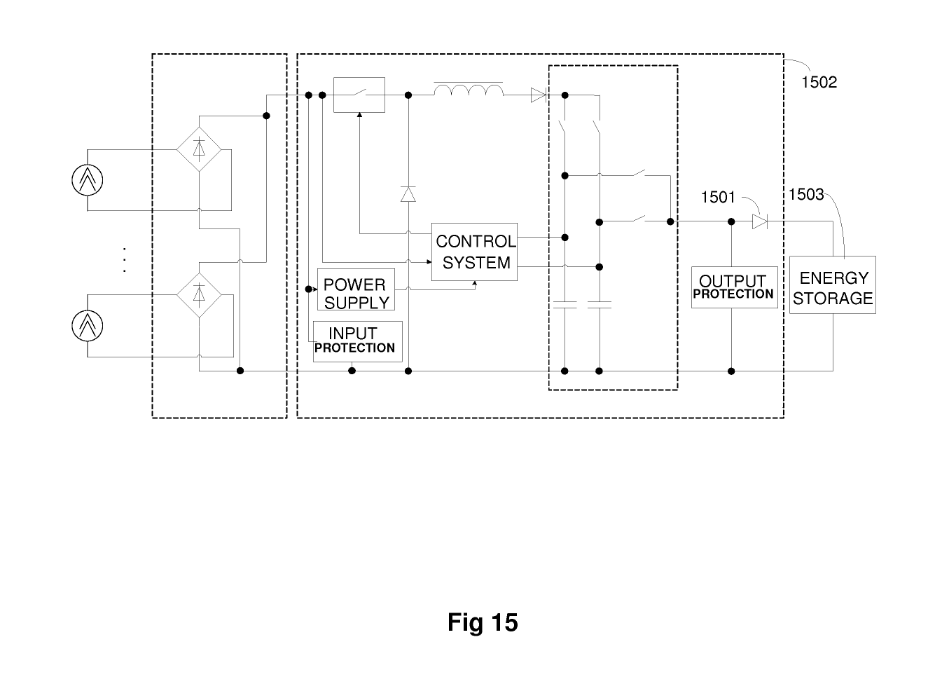

FIG. 15 shows a functional structure of adaptive loader device 1502 with internal output decoupling device constructed according to an exemplary embodiment of the present invention. The difference from the device described on FIG. 14 is presence of the internal decoupling device 1501 connected at the output of electronic loader 1502. Internal decoupling device 1501 is needed in order provide possibility of parallel connection of the adaptive loaders 1500 and prevents discharge of energy storage element back to the electronic loader 1502. Reverse polarity protection should be provided in case of external energy storage element 1503 connection.

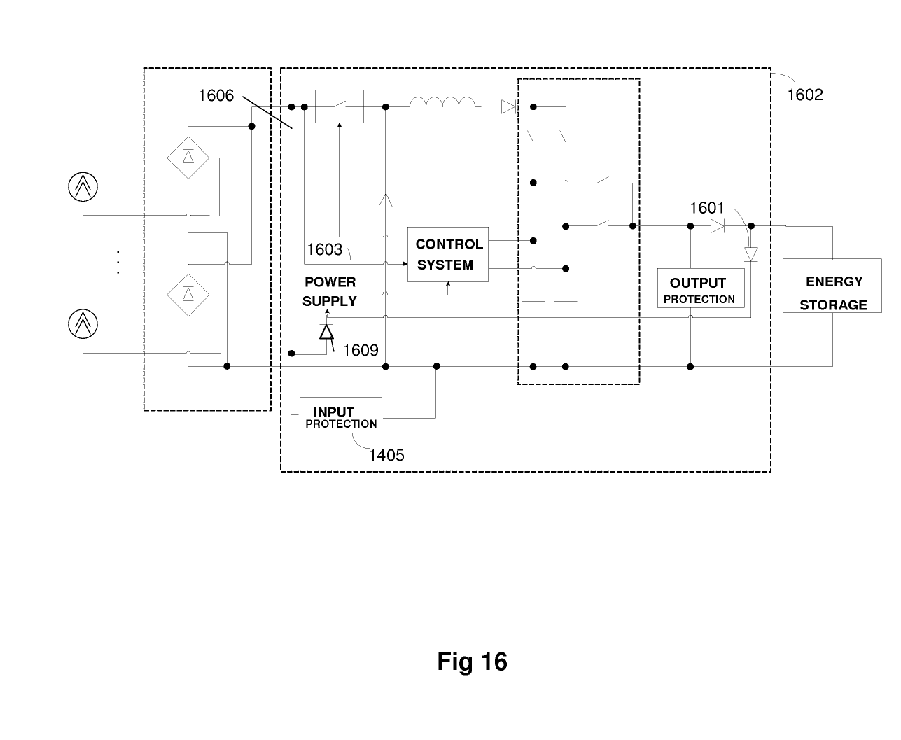

FIG. 16 shows a functional structure of adaptive loader device 1602 with internal power supply 1603 fed from the output of electronic loader 1602 constructed according to an exemplary embodiment of the present invention. The difference from the device 1502 described on FIG. 14 is powering of the internal power supply 1603 from the output of electronic loader 1602 through the decoupling diode 1601 and from the input through the optional decoupling diode 1609. In this case internal supply 1603 receives input energy from the input 1606 only when the output energy is insufficient for powering of the control networks of adaptive loader 1600. In this case output energy can be used for powering control networks during the absence of the input stimuli for immediate start-up of electronic loader 1602 when required.

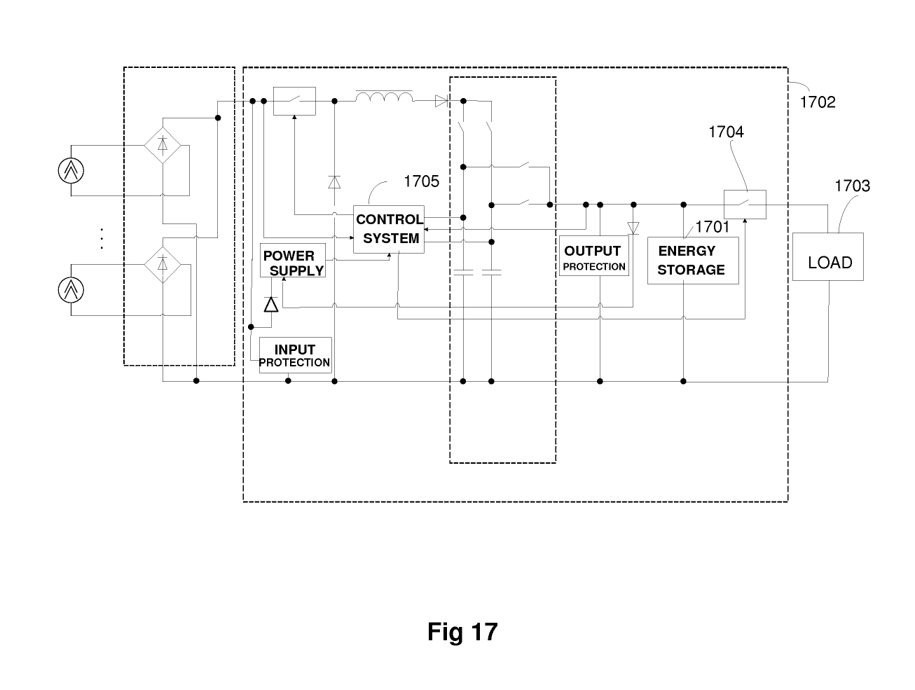

FIG. 17 shows a functional structure of adaptive loader device 1702 with internal storage element 1701 constructed according to an exemplary embodiment of the present invention. The difference from the device described on FIG. 16 is incorporated internal energy storage element 1701 into electronic loader 1702, feeding the load 1703 and absence of output decoupling element 1501 see FIG. 15. Controlled switch 1704 is connected at the output of electronic loader 1702 in order to disconnect the load from energy storage element 1701 at fault conditions like overload or low voltage of energy storage element 1701. Control system 1705 eliminates overcharge of energy storage element 1701.

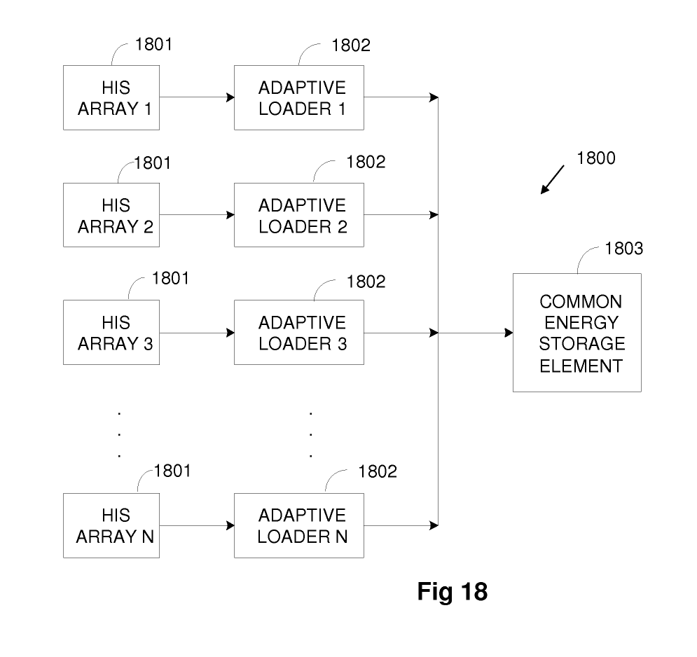

FIG. 18 shows a distributed system 1800 for adaptive loading of HIS arrays constructed according to an exemplary embodiment of the present invention. Distributed system 1800 comprises several HIS arrays 1801. Each HIS array 1801 may be a single HIS, such as a single piezoelectric element or a piezoelectric generator, or it may be an array or HIS elements combined for example as seen in FIG. 11, or a combinations of single HIS elements and arrays of HIS elements. The output terminals of each HIS array 1801 are connected to corresponding input terminals of each corresponding adaptive loader 1802. Each adaptive loader 1802 may be one of the exemplary embodiments of adaptive loaders depicted above. Corresponding output terminals of each adaptive loader 1802 are connected in parallel to the corresponding terminals of common energy storage element 1803, wherein the electronic loaders 1602 operates as current sources charging a common energy storage element 1803. Reverse polarity protection means should be provided at each output of adaptive loader 1802 in order to ensure safe system operation when one of the adaptive loaders 1802 is connected with reverse polarity to common energy storage element 1803 or in case reverse polarity connection of the common energy storage element 1803.

Due to the fact that adaptive loader loads the HIS with impedance matching there is a possibility to build measurement/acquisition systems 1900 in order to measure input stimuli value based on described adaptive HIS loading method.

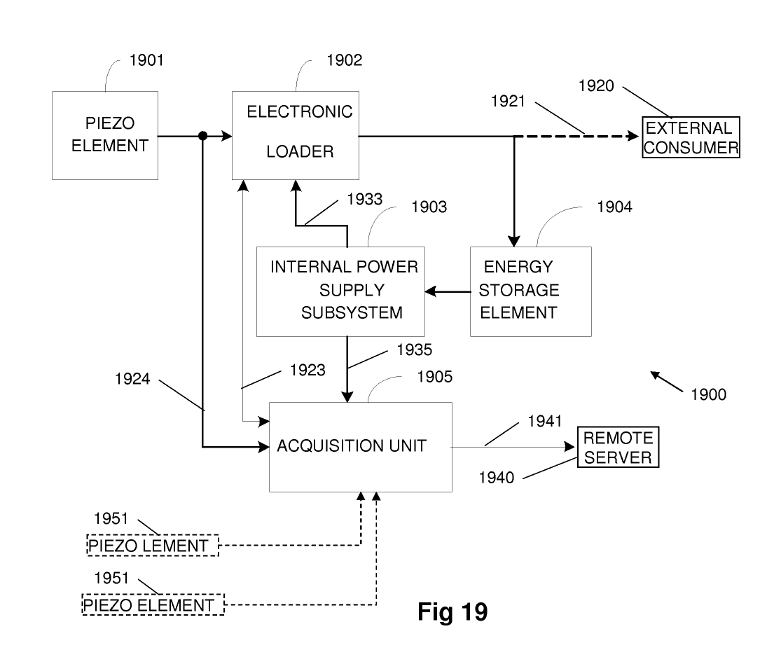

FIG. 19 shows example architecture of acquisition system 1900 constructed in according to an exemplary embodiment of the present invention. Output of piezo-element 1901 is connected to the input of electronic loader 1902 and input of acquisition unit 1905. Output of electronic loader 1902 is connected to energy storage element 1904 and may optionally be connected to external consumer 1920 via optional line 1921. Storage element 1904 is connected to power supply subsystem 1903 which powers all modules of the acquisition system 1905, and optionally the electronic loader 1902 via lines 1935 and 1933 respectively. In some embodiments, electronic loader 1902 and acquisition unit 1905 have full duplex interconnection 1923 in order to adapt loading factor of electronic loader and in order to receive required measurement accuracy and transmitting of real loading factor for each measurement. Output of acquisition unit 1905 is fed to external system.

System operates in the following way: Mechanical input stimuli produce the reaction of piezoelement 1901 which is expressed in electrical energy on its output terminals. Loading factor of electronic loader 1902 is changes in such a way that it provides correct measurement with sufficient accuracy for a given conditions. Measured by acquisition unit 1905 value of output voltage of piezo-element 1901 and actual loading factor value of electronic loader 1902 at each measurement point are taken into account in calculations of input stimuli value. Output data 1041 is communicated to a remote server 1940 for further analysis.

The main advantage of this method is that energy applied to the load of the piezo-element is converted and can be used. It means that the same HIS can be used for both measurement and energy producing.

It should be noted that a plurality of piezoelectric elements 1901 may use within the same system 1900. For example, each piezoelectric element 1901 may be connected to a corresponding electronic loader 1902 having a communication line 1923. The same acquisition unit 1905 and optionally other subsystems such as internal power supply 1903, and energy storage 1904 may be common. For drawing clarity this optional additional electronic loaders 1902 are not shown in this figure. Energy from the optional additional electronic loaders 1902 is optionally combined for example as depicted in FIG. 18.

Alternatively, some piezoelectric elements may be used as sensors only. For example, the optional piezoelectric element or elements 1951 may be connected to the acquisition unit 1905 and used as sensors without utilizing their energy. Preferably, such sensors are smaller than energy producing piezoelectric elements 1901, and thus they may be cheaper, and may produce smaller signals that are easier to acquire.

Preferably, acquisition unit 1905 comprises an A/D converter or converters to digitize signals such as signal 1924 and optionally other analog signals, and comprises a communication subunit for communication with the remote server 1940. It should be noted that remote server 1940 may be located locally or remotely, and may be connected via wire or wireless communication channels to the acquisition unit 1905.

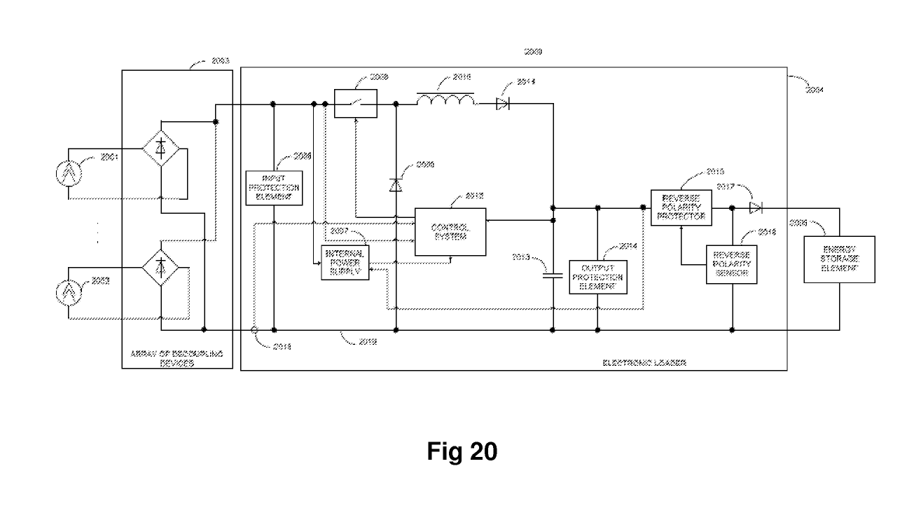

FIG. 20 shows system 2000 and a basic functional structure of adaptive loader device 2004 constructed according to an exemplary embodiment of the present invention. Adaptive loader device 2000 combines the multi-source combining 2003 depicted in FIG. 11. Outputs of the HISs represented on figure as current sources 2001 and 2002 are connected to the corresponding inputs of array of decoupling devices 2003. All outputs of decoupling devices are connected in parallel. Array of decoupling devices 2003 can be implemented on half wave rectifiers in case of DC input signals and on full wave rectifiers in case of AC input signals. Output terminals of array of decoupling devices 2003 are connected to the corresponding input terminals of electronic loader 2004. Output terminals of electronic loader 2004 are connected to the corresponding terminals of a load such as energy storage element 2005.

Electronic loader 2003 comprises an input protection element 2006 connected across the input terminals of electronic loader 2003 in order to protect electronic converter during input overvoltage conditions. Input terminals of internal power supply 2007 are connected to appropriate input terminals of electronic loader 2003. Output terminals of internal power supply 2007 are connected to the appropriate terminals of control system 2012. Input of power conversion stage implemented as buck converter and comprising controllable switch 2008, inductor 2010, diode 2009, decoupling diode 2011, and capacitor 2013. Said buck converter is controlled by control system 2012. Control system 2012 receives feedback signals from input voltage, input current sensor 2018 and output voltage. Output protection element 2014 is connected across the terminals of capacitor 2013 in order to protect the output of electronic loader 2003 during output overvoltage conditions. Protection elements 2006 and 2014 may be elements such as Zener diode, transient voltage suppressing diode (TVS diode) or vanstor connected between the terminal on which over-voltage may develop and the common wire 2019. Protection element 2014 should be chosen so that provide overvoltage protection and load role in case of disconnection of energy storage element 2005. Power supply 2007 may optionally be of the construction 1000 seen in FIG. 10, or other appropriate construction. Alternatively, external power supply may be used, powered for example by the energy storage 2005. Reverse polarity protector 2015 is connected with its input terminal to the positive terminal of capacitor 2013. Output terminal of reverse polarity protector is connected to anode of decoupling diode 2017. Reverse polarity sensor 2016 is connected between output terminal of reverse polarity protector 2015 and common wire 2019. Cathode of decoupling diode 2017 is connected to positive terminal of external energy storage element 2005.

The function of the control system 2012 of the exemplary embodiment 2000 is to control the loading factor in such a way that the input energy yield of the converter is maximized. This can be achieved as follows. Control system 2012 samples the input power of the electronic loader 2004 where input power is a product of sampled input voltage and input current. Each time the input voltage is changed, the loading factor is varied so as to maximize the input energy rate. The sampling frequency is set to be higher than the characteristic frequency (or rate of change) of the input so that for each input state it is possible to find the value of the loading factor leading to the maximal input energy rate. As a result of this “instantaneous” optimization, the system constantly follows the physical input to the HIS whether it is the changing mechanical pressure in a piezoelectric generator, changing heat input in a thermo-generator, or varying insolation in a Photo Voltaic (PV) system. In implementation of the invention for different HIS sources, characteristic times of the varying inputs should be taken into consideration. For example, in piezoelectric systems the characteristic times of the mechanical pressure vary from a few milliseconds up to several hundred milliseconds; in thermoelectric systems characteristic times of the heat input range from several seconds up to several minutes, and so forth. Correct estimation of the temporal change of the HIS input allows one to build an optimal loading profile of HIS using an adaptive DC/DC converter and, as result, to achieve maximal output energy (maximal conversion efficiency).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. An adaptive loader for time varying, non-linear high-impedance power sources (HIS) comprising:
an electronic converter, matching the impedance of said HIS to a load;
at least one sensor; and
a control system, controlling the loading factor of said electronic converter in response to signals from said at least one sensor to ensures impedance matching between said time varying HIS and the load.

2. The adaptive loader of claim 1, wherein said HIS is a piezoelectric generator producing time varying electrical signal in response to time varying mechanical strain.

3. The adaptive loader of claim 2, wherein duty cycle or pulse width of said electronic converter is controlled by said control system.

4. The adaptive loader of claim 1, wherein said load is a rechargeable battery.

5. The adaptive loader of claim 1, wherein said adaptive loader is powered by said HIS or by said rechargeable battery.

6. The adaptive loader of claim 5, comprising a protector protecting said electronic adaptive loader against high voltage transients from said HIS.

7. The adaptive loader of claim 1, further comprising an intermediate electronic converter between said HIS and said electronic converter.

8. A method for construction of adaptive loader for non-linear high impedance power sources (HIS), said adaptive loader based on electronic conversion means load high impedance power sources proportionally to the input stimuli and ensures impedance matching between HIS and its load (input impedance of said adaptive loader) at each point of input stimuli trajectory in order to receive maximum energy from HIS, said loader comprising:
an electronic loader;
control means of an electronic loader including required sensing means;
an energy storage element; and
a said loader power supply means.

9. The method of construction of claim 8, wherein sensing means used for impedance matching comprising input voltage and output energy sensing means or input voltage and input current sensing means or output voltage and output current sensing means or a combination thereof.

10. The method of construction of claim 8, wherein HIS is a piezo-electric element.

11. The method of construction of claim 8, wherein energy storage element is connected to external electrical networks.

12. The method of construction of claim 8, wherein an overvoltage protection element is connected to the output of the adaptive loader for cases of storage element cannot receive energy.

13. The method of construction of claim 8, wherein control means ensure optimal loading and safe operation of an input HIS for all, including abnormal, conditions.

14. The method of construction of claim 8, wherein control means ensures optimal and safe operation of an adaptive loader for all, including abnormal, conditions.

15. The method of construction of claim 8, wherein an electronic loader uses the following technique for impedance matching which comprising following steps:
measuring of output energy and input voltage at every measurement point;
determining the derivative of output energy and input voltage at each measurement point;
estimating and changing the loading factor in order to receive maximum energy in the next point.

16. The method of construction of claim 8, wherein output energy sensing means use the sample on hold technique combining measurement and power conversion functions for fast changing processes like energy of piezo-electric converters.

17. The method of construction of claim 8, wherein an electronic loader enables connection a number of input HIS limited only by maximal power of an electronic loader.

18. The method of construction of claim 8, wherein an electronic loader provides a protection means of an input HIS.

19. The method of construction of claim 8, wherein an electronic loader provides reverse polarity protection means of its output.

20. The method of construction of claim 8, wherein a buffer converter can be connected to the output of said electronic loader, said buffer converter separates said electronic loader from the load; said buffer converter comprising input capacitor and output driver; said input capacitor is an intermediate storage element for said electronic loader and a buffer element for the said output driver feeding the load.

21. The method of construction of claim 20, wherein said output driver operates in current mode and operates as an output charger feeding an external storage element.

22. The method of construction of claim 20, wherein some loaders connected in parallel are capable of feeding a common external storage element.

23. The adaptive loader of claim 1, wherein said HIS comprising:
an array of decoupling devices for connection of multiple HIS feeding an electronic loader;
an input voltage sensor;
output energy sensing means use the two state sample-and-hold technique combining measurement and power conversion means;
an electronic loader feeding an external energy storage element through an internal decoupling device;
control means of said electronic loader; and
an internal power supply for powering said electronic loader capable of receiving energy from internal energy storage element or from external storage element.

24. Devices of claims 23 enter in sleep mode when the input voltage is absent for a defined period of time in order to minimize energy of an adaptive loader and wake up when the input voltage from HIS is applied again.

25. Devices of claims 23, have an input current and voltage limiting device for input emergency conditions.

26. The method of claim 8, wherein an adaptive loader has an output protective device for emergency conditions and provides functions of load when adaptive loader is unloaded.
